(19) United States
(12) Patent Application Publication
(10) Pub. No.: US 2023/0087557 A1
(43) Pub. Date: Mar. 23, 2023

(54) SYSTEM FOR PRIVACY PROTECTION DURING IOT SECURE DATA SHARING AND METHOD THEREOF

(71) Applicant: Huazhong University of Science and Technology, Wuhan Ciyt (CN)

(72) Inventors: Weiqi DAI, Wuhan City (CN); Shuyue TUO, Wuhan City (CN); Hai JIN, Wuhan City (CN); Deqing ZOU, Wuhan City (CN)

(21) Appl. No.: 17/661,988

(22) Filed: May 4, 2022

(30) Foreign Application Priority Data
Sep. 17, 2021 (CN) 202110651418.9

(51) Int. Cl. H04L 9/06; H04L 9/00; H04L 9/40

(52) U.S. Cl. CPC H04L 9/0637; H04L 9/50; H04L 63/0442; H04L 63/105

(57) ABSTRACT

The present invention provides a system for privacy protection during IoT secure data sharing and a method thereof. The present invention relates to IoT data sharing, wherein it allows users to securely share data encrypted through decentralized attribute-based encryption on a blockchain-based platform without disclosing their attribute permission, so that individual users will not be identified according to their attributes, thereby protecting user privacy. The present invention also enables users sharing encrypted data and achieving traceability and accountability in the event of privacy breach. The present invention further provides an approach to verifying user permission using an attribute-based zero-knowledge proof, so as to securely and reliably verify whether permission of a data user is real. The present invention is suitable for solving existing problems about secure sharing and privacy protection of IoT data by verifying user identity and securely sharing user privacy data on a zero-knowledge basis.

This application claims the benefit of the Chinese Patent Application No. CN 202110651418.9 filed on Jun. 10, 2021, which is hereby incorporated by reference as if fully set forth herein.

### BACKGROUND OF THE INVENTION

### 1. Technical Field

The present invention relates to Internet of Things (IoT) Technical Field, and more particularly to a system for privacy protection during IoT secure data sharing and a method thereof.

### 2. Description of Related Art

In the modern world, Internet of Things devices are increasingly becoming an essential part to our social and daily life (such as in the forms of medical devices and implantable IoT devices). The data collected by extensively deployed IoT devices in IoT systems may be used in commerce, healthcare and other applications to enable smart operation. For example, a basic healthcare setting may include data owners, data users and various other stakeholders. The data owners may send their aggregated data to the data user through some cloud services. Then the data users may use these shared data to perform a series of operations. Since such data are personal and may be sensitive, they have to be kept confidential and protected from accidental disclosure during transmission and processing. After data are shared, the data owners may review data processing records to ensure accountability. Privacy is another key feature, for hiding attributes that can identify users, such as authorization relationship, user locations, etc. With the progress of information technologies, like artificial intelligence, big data, and IoT, data are getting more and more valued and have been regarded as important assets of companies and a drive for continuous innovation. Therefore, the importance of protecting data security during in every aspect from collection, transmission, use, to sharing is a matter of course.

In the modern society, we media, such as live stream and short video, are in power, turning every user an information producer, leading to fragmentation of information sources. Online-offline deep applications of the Internet, including O2O and B2C, are explosively developing in all aspects. Meanwhile, as the mobile Internet contiguously permeates into various applications in a highly flexible and convenient way, making the Internet more a as part of our life than ever. As a result, a huge amount of user data from both the real world and the network world rapidly produced and accumulated on the Internet platform provides big data analysis and artificial intelligence with a supportive growth environment and creates great opportunities for Internet-based cross-border integration. However, there are two sides to every door. Without proper protection, data abuse and data breach highlight the problem of privacy breach and even breed crimes. The breach exposing the data of 50 million Facebook users in 2018 has revealed seriousness of data protection. During data sharing, in spite of encryption, information of user attributes and authorization relationship is usually not well protected, bringing about risks of privacy breach.

Blockchains represent a distributed ledger technology that is advantageously decentralized, security trusted, incorruptible, and programmable. In the context of a block information system, privacy refers to some sensitive data or deep properties obtained by analyzing these data. Owners of such data usually do not want to see they are disclosed. In the data structure of blockchains, information is stored in and communicated among peers. For verifying whether the information is correct, information on peers is open to other peers. In general, the information has to be disclosed is transaction contents. Every peer keeps a complete ledger, in which data about transactions are completely open, so that anyone can check accounts and transactions of other people through a particular technical means. Due to its openness and transparency, a blockchain system places user transaction privacy and account privacy under serious threats. At present, measures to protect privacy data in blockchains are increasingly diverse. In view of the deep development of the blockchain technology, privacy protection schemes using blind signatures are no more satisfying options, making current efforts for privacy protection turn to public blockchains and consortium blockchain. Existing privacy protection manes may be classified into three types according to the objects they protect. The first one is privacy protection directed to transaction information, such as transaction senders, transaction receivers, and transaction amounts, and includes tumbling, ring signatures, and confidential transactions. The second type of privacy protection is specific to smart contracts, and includes zero-knowledge proofs, secure multiparty computation, and homomorphic encryption. The third type is focused on privacy protection for on-chain data, and mainly includes solutions like ledger isolation, private data, and data encryption authorization access. A blockchain can use the aforementioned solutions, i.e., encryption protocols, consensus mechanisms, tumbling, and zero-knowledge proofs to provide encryption protection to user account data or transaction data through keys, consensus proofs, and tumbling protocols, thereby ensuring user data security.

In the prior art, for example, a Master's degree thesis titled “Research on Blockchain-Based Medical Data Sharing Scheme” (University of Electronic Science and Technology of China, China) has proposed a blockchain-based medical data sharing scheme that combines the blockchain technology and mechanisms for secure sharing and privacy protection of IoT data. The known scheme uses a blockchain to provide a decentralized medical data sharing platform, so as to prevent data tampering and ensure data confidentiality. Meanwhile, the known scheme further allows a user to add or revoke permission for a third party to access his/her medical data. Particularly, the known scheme comprises: 1. Scheme initialization: for setting parameters, which means a user just joining a blockchain network has to select his/her own private/public key pair to be used later for signing messages and verifying permission; 2. Data publication: for data owners to collect medical data and publish the data to the blockchain, which specifically involves using keys randomly generated for symmetrical encryption to encrypt the original data, computing the Hash value of a ciphertext, generating a dynamic accumulator, inputting ciphertext, its Hash value, and parameters of the dynamic accumulator to a cloud server, then incorporating the Hash value of the ciphertext into a transaction proposal, and sending the proposal to the blockchain network; 3. Data request: for a data requester to ask the data owner for access to the medical data, wherein if the data requester agrees, the data owner first adds the data requester to an authorization collection related to the data, updates the dynamic accumulator as well as related proofs, and at last notify the data requester by providing the data requester with a proof; and 4. Data acquisition: the data requester first sends the proof acquired from the data publisher to the cloud server, and then the cloud server verifies whether the data requester possesses access permission, if yes, the cloud server sends the ciphertext to the data requester, the data requester computes the Hash value of the ciphertext to ensure that the data have not been tampered, and at last the data requester decrypts the ciphertext coming from the cloud server so as to obtain the plaintext of the medical data.

In the foregoing technical scheme, the data to be shared are symmetrically encrypted. Whether the symmetrical encryption algorithm is reliable depends on how the keys are stored, but, unfortunately, secure exchange of the keys in the prior art is not guaranteed. Thus, the data to be shared so encrypted are subject to attacks and breach. Meanwhile, in the known data sharing method, user permission and user identity are published, making protection of user privacy an unachievable object.

To address the foregoing issue, China Patent Application Publication No. CN112564903A has disclosed decentralized access control system for data secure sharing in a smart electric grid and its method, wherein user identity information is hidden. The prior-art patent uses the zero-knowledge proof protocol. Thereby, for a user asking for a secret key, the grid center can generate the corresponding secret key without knowing the identity information of the legal user. Furthermore, during interaction between the cloud server and the user, the user submits his/her identity certificate to the cloud server. Herein, the identity certificate is generated by a trusted identity management center. The identity certificate is a result of blinding the user identity, so it does not reveal identity information of the user. Moreover, plural authorization agencies jointly manage user attributes in the system and generate corresponding secret keys. When a user is revoked, his/her identity certificate in the cloud secret key list and his/her cloud server secret key will be deleted at the same time. With outsourced encryption and outsourced decryption added to the signcryption stage and the de-signcryption stage, respectively, the prior-art system and method help to reduce compute overheads at the user side and improve compute efficiency of the system. During interaction between the user and the cloud server, if the user wants to download a ciphertext from the cloud server, the cloud server has to verify whether the user identity is legal, if verification succeeds, the cloud server partially decrypts the ciphertext and sends it to the user. Otherwise, the cloud server will not send any effective information to the user.

In the foregoing technical scheme, although the identity certificate is generated by hiding the user identity, the corresponding relationship between the identity certificate and the user identity is unique, and this indirectly prove the user identity. Besides, since the cloud server is currently not a secure environment, data are typically stored into the cloud server in the encrypted form. Yet in the known scheme the identity certificate is simply open to the cloud server, and this indirectly discloses the user identity. In addition, while the known technical scheme notes the concept of using a zero-knowledge proof to hide user identity, throughout its disclosure, there is not a word describing how to do this, leaving the concept an unsolved issue to the art.

Further, since there is certainly discrepancy between the prior art comprehended by the applicant of this patent application and that known by the patent examiners and since there are many details and disclosures disclosed in literatures and patent documents that have been referred by the applicant during creation of the present invention not exhaustively recited here, it is to be noted that the present invention shall actually include technical features of all of these prior-art works, and the applicant reserves the right to supplement the application with technical features known in the art as support.

### SUMMARY OF THE INVENTION

In view of the shortcomings of the prior art, the present invention provides a system and a method that solve issues of privacy protection for IoT-based secure data sharing. The present invention relates to IoT data sharing, and allows users to securely share attribute-based encrypted data on a blockchain-based platform without disclosing their attribute permission so that individual users will not be identified according to their attributes, thereby protecting user privacy. The present invention also enables users sharing encrypted data and achieving traceability and accountability in the event of privacy breach. The present invention further provides an approach to verifying user permission using an attribute-based zero-knowledge proof, so as to securely and reliably verify whether permission of a data user is real. The present invention is suitable for solving existing problems about secure sharing and privacy protection of IoT data by verifying user identity and securely sharing user privacy data on a zero-knowledge basis.

A method for privacy protection during IoT secure data sharing provided by the present invention at least comprises: having an edge server perform verification on an attribute-based zero-knowledge proof coming from a data user requesting for download permission; if the verification succeeds, having the data user transmit information, which at least contains a storage address and is returned by the edge server, to a cloud server to file an application for downloading a ciphertext; having the cloud server perform verification on the application, and if the verification succeeds, return the ciphertext to the data user, wherein the ciphertext is obtained by encrypting, by a data owner, to-be-shared data through decentralized attribute-based encryption (DABE); and having the data owner decrypt the ciphertext based on DABE so as to obtain original data.

According to a preferred embodiment, the data owner establishes and constitutes an attribute list, encrypts the to-be-shared data using DABE to obtain the ciphertext, and generates a commitment protocol associated with the attribute permission list.

According to a preferred embodiment, the data owner transmits the ciphertext and the commitment protocol to an edge server to upload the ciphertext to the cloud server, thereby obtaining the storage address associated with the ciphertext.

According to a preferred embodiment, the edge server uses the storage address to compose related permission, writes the permission into an access control list (ACL) on the blockchain, and returns the storage address to data owner.

According to a preferred embodiment, the information that is returned by the edge server after verifying the attribute-based zero-knowledge proof transmitted by the data user at least includes a verification credential, wherein the verification credential is used by the cloud server to determine whether the application for downloading the ciphertext is to be approved.

According to a preferred embodiment, the data user acquires, from an attribute authorization agency, an attribute key corresponding to the ciphertext, and decrypts data of the ciphertext based on the attribute key.

According to a preferred embodiment, the method further comprises: performing system initialization to generate global security parameters required by DABE and the attribute-based zero-knowledge proof, wherein each said attribute authorization agency generates a corresponding private/public key pair.

The present invention also provides a method for privacy protection during IoT secure data sharing, at least comprising: making the data owner establish and constitute an attribute list, encrypt the to-be-shared data using DABE to obtain the ciphertext, and generate a commitment protocol associated with the attribute list; having the data owner transmit the ciphertext and the commitment protocol to an edge server to upload the ciphertext to the cloud server, thereby obtaining the storage address associated with the ciphertext; and having the edge server use the storage address to compose related permission, write the permission into an ACL on the blockchain, and return the storage address to data owner.

The present invention also provides a method for privacy protection during IoT secure data sharing, at least comprising: having a data owner establish an attribute permission policy and constitute a non-interactive commitment protocol according to the policy; based on an attribute and an address of a data user, generating an attribute-based zero-knowledge proof that accords with the commitment protocol; wherein neither the commitment protocol nor the attribute-based zero-knowledge proof contains any attribute associated with the respective corresponding users; using a zero-knowledge proof contract pre-compiled based on the commitment protocol to perform the verification on the attribute-based zero-knowledge proof; and outputting a verification result.

According to a preferred embodiment, the commitment protocol is obtained through a process of constituting an attribute tree based on the attribute list and computing an attribute tree root and a given random number, and the process may comprise: using a pseudo random number sorting function to sort the attribute list and filling a certain number of 0s in the attribute list to ensure list length consistency and thereby obfuscate the attribute list; and using a Collision Resistant Hash Function to construct the Merkle tree having a fixed depth to store the attribute list, and figuring out the Merkle tree root through computing.

The present invention also provides a system for privacy protection during IoT secure data sharing, at least comprising plural modules, wherein the modules are assigned to execute at least one of steps of:

being used by a data owner to encrypt to-be-shared data by means of DABE, and/or store a ciphertext and permission to a cloud server;

being used by a data user to prove his/her attribute permission and file an application for obtaining a data storage address;

being used by an edge node to perform verification on user permission and return a verification credential and the ciphertext data storage address to the data user;

being used by the data user to, after obtaining the credential and the storage address, filing an application at the cloud server for data downloading; and

being used by the cloud server to perform verification on the credential for effectiveness and return the ciphertext to the data user.

Generally, the technical schemes according to the present invention provide the following advantages over the prior art:

(1) The present invention provides a model for securely sharing encrypted data and protecting user privacy in an IoT data sharing system, through which data can be encrypted and shared securely in a way the user data privacy is protected, without affecting data sharing performance;

(2) The present invention provides a model for verifying user attribute permission in a IoT data sharing system based on the zero-knowledge proof technology, which combines a zero-knowledge proof and decentralized attribute-based encryption, so that when a data user and a data owner share DABE encrypted data therebetween through a cloud server and a blockchain, permission of the data user can be verified simply and efficiently. Different from the traditional practice of acquiring encrypted data directly, the present invention uses an attribute-based credential as permission of a data user, so as to keep user privacy undisclosed, thereby preventing privacy breach otherwise caused by exposure of attributes of data users;

(3) The present invention provides a distributed scheme for verification of user permission in an IoT data sharing system constructed from blockchains. Different from the traditional scheme performing centralized verification on zero-knowledge proofs, the model enables decentralized verification among multiple miners, thereby eliminating the possibility that a centralized verifier counterfeits verification results of zero-knowledge proofs; and

(4) The present invention enables an IoT data sharing system to keep open and transparent throughout the entire process of data sharing, so that every step is traceable, thereby making an accountability possible in the event of privacy breach.

### BRIEF DESCRIPTION OF THE DRAWINGS

FIG. 1 is a simplified flowchart of a method for privacy protection during IoT secure data sharing according to the present invention;

FIG. 2 is a simplified diagram showing information interaction among modules in a system for privacy protection during IoT secure data sharing according to the present invention; and

FIG. 3 is a simplified architecture of combination of a zero-knowledge proof and decentralized attribute-based encryption according to the present invention.

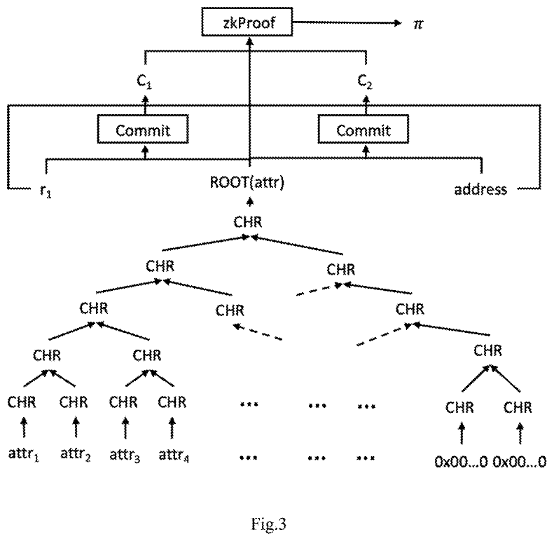

### DETAILED DESCRIPTION OF THE INVENTION

The present invention will be further detailed below with reference to accompanying drawings and particular embodiments for further explaining its objectives, technical schemes and advantages. It is to be understood that these embodiments are only illustrative but not limiting. Moreover, the technical features referred to in the embodiments of the present invention may be combined with each other in any manner as long as no conflicts are caused therebetween.

For easy understanding, the terminology used in the disclosure is explained below.

Internet-of-Thing (IoT) is a network concept about, according to a predetermined protocol, using an information sensing device, such as a radio frequency identification (RFID) device, an infrared sensor, a global positioning system, or a laser scanner, to connect any article to the Internet for information exchange and communication, so as to realize smart identification, positioning, tracing, monitoring, and management.

A blockchain is a series of transaction records (also known as blocks) whose contents are connected and protected cryptographically, and is a novel application mode for computer technologies like distributed data storage, point-to-point transmission, consensus mechanisms, and encryption algorithms. A blockchain is essentially a decentralized database, and, as the underlying technology of Bitcoins, is a string of data blocks associated with each other using a cryptographic method, wherein every data block contains information of one transaction in the Bitcoin network, for verifying its information effectiveness (anti-counterfeiting) and generating the next block. The blockchain technology is advantageously decentralized, tamper-proof, and trusted. Therein, decentralized means that since a blockchain stores data using the P2P technology, there is not an authority agent in a blockchain, and all peers have basically the same rights and obligations. The stoppage of any peer will not affect the overall operation of the system. A blockchain is tamper-proof because once a transaction result is verified by peers, it is stored into a ledger to generate a chronologically recorded, tamper-resistant, trusted database, thereby preventing illegal behaviors. A blockchain is trusted because it employs a consensus mechanism, and there are strict algorithmic rules for peers to update information in blocks, thereby realizing information sharing as a result of multi-party consensus decision making. It guarantees a trustable process of data recording, and thus a trusted network can be built without the need of any third-party agency.

The blockchain consensus mechanism is a mechanism through which blockchain peers throughout the network come to a consensus in terms of block information. It guarantees that a new block can be accurately added to the blockchain and blockchain information stored in all peers is consistent without forks, so as to resist malicious attacks. One merit of the blockchain technology is consensus governance of data. In other words, all users have equal management permission over on-chain data, so the risk of operational errors by individuals can be eliminated. The blockchain technology uses global consensus to address issues related to data decentralization, and uses zero-knowledge proofs to solve problems about verification, thereby enabling use of privacy data in an open and decentralized system, so as to meet the requirements of an Internet platform while keeping a part of data only in hands of users.

A peer is a fabric peer entity shouldering some particular functions for its underlying blockchain network. Every entity communicates with each other according to the gRPC protocol, and jointly maintains the consistency of their ledgers. Peers can be divided into, by their respective functions, submitters, endorsers, and committers. Therein, a submitter initiates a transaction process to the blockchain network. An endorser examines and endorses the transaction proposal. A committer confirms the transaction peer and maintains the structure of the ledger.

A zero-knowledge proof is a probability-based verification method. It allows a verifier without the knowledge of the exact value in the commitment to be sure that the value hidden in the commitment is in a certain interval or whether two commitments hide the same value. This makes transaction data more private because no one knows the exact transaction information except for the transactor. A zero-knowledge proof is composed of two parts, including a prover that claims some proposition as true and a verifier that verifies the proposition as true. A zero-knowledge proof enables a prover to convince a verifier that some assertion is correct without providing any useful information to the verifier. In other words, a prover can not only prove itself as a legal owner of some equity but also prevent breach of related information. Stating differently, the “knowledge” open to the exterior is “zero.” With the zero-knowledge proof technology, association relationship can be verified for data in the form of ciphertext, so as to protect data privacy while enabling data sharing.

DABE is the acronym of decentralized attribute-based encryption. Attribute-based encryption is about binding user identity with a series of attributes, and setting an attribute collection and an access structure for a user secret key or a ciphertext, so that only when the attribute collection and the access structure match each other can decryption be performed, thereby realizing one-to-many encryption communication and fine-grained access control to files. Thus, it is more suitable for encryption applications where data sharing and privacy protection are required. Attribute encryption can be further divided into key-policy attribute-based encryption (KP-ABE) and ciphertext-policy attribute-based encryption (CP-ABE). In CP-ABE, the ciphertext and the access policy are associated with each other, while the user key and the attribute collection are corresponding to each other.

Attribute encryption refers that in a DABE system, an encryptor associates to-be-encrypted data with a set of attributes, so that permission authorized to access a primary key sends different secret keys to users, wherein the user secret keys are relevant to the access structure in the attributes and reflect access policies attributed to corresponding users. The corresponding decryption algorithm allows a user to use the attached secret key to decrypt data, provided that the access policy designated by the secret key permits so.

An authority center is a global management center for attribute-based encryption. It serves to generate a random value that is bound to the global unique identifier of a user.

An attribute authorization agency is a global management center for decentralized attribute-based encryption. It independently assigns specific attribute fields and generates the attribute pk for data owners. In addition to encryption, it works in decryption by creating a secret key that corresponds to the attribute and based on the global unique identifier of a user. The term “pk” may refer to a public key of the data owner. The corresponding hash abstract acts as the account of the data owner. The pk-corresponding hash abstract may be used as the address of the data owner in the blockchain network. The term secret key (SK), as mentioned previously, is a secret key of a data owner, and its corresponding hash abstract acts as the password for the data owner to use for decryption.

A data owner is the original owner of data collected by an IoT system. It can share data with other users.

A data user is an IoT user who applies to operate data owned by others.

An edge node refers to an edge server, having high computing capacity.

A cloud server refers to a centralized, cloud-based storage server, having certain storage capacity.

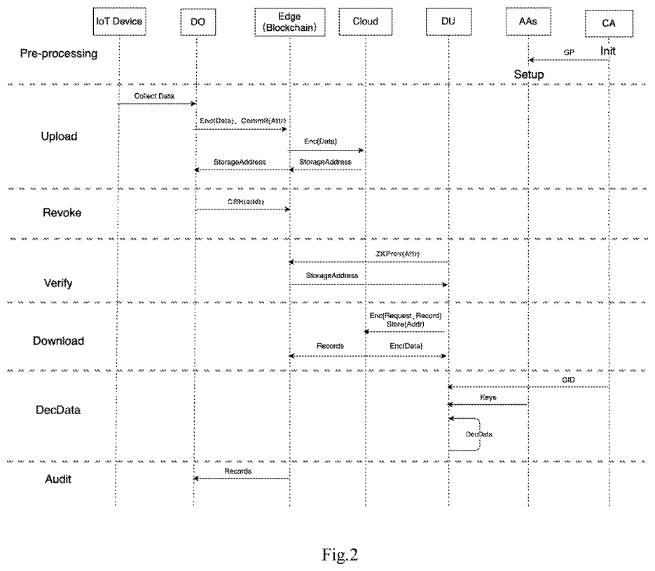

For facilitating easy understanding of the present invention with reference to the accompanying drawing, abbreviations and acronyms used in FIG. 2 are explained below:

| | |
|---|---|
| DecData: | Decrypt Data, i.e., decrypted data/plaintext. |
| IoT device: | Internet of Things (IoT) device |
| DO: | Data Owner |
| Edge (Blockchain): | Edge node in a blockchain |
| Cloud: | Cloud server |
| DU: | Data User |
| AAs: | Attribute Authority Server, i.e., an attribute |
| | authorization agency. |
| CA: | Authority Center, a global management center for |
| | decentralized attribute-based encryption, serving |
| | to generate a random GID to be bound to the |
| | global unique identifier of a user. |
| Setup: | Initialization |
| GP: | Global Parameter |
| Init: | Initialization function |
| Collect Data: | Collected data |
| Enc(Data): | Encrypt(Data), encrypted (data)/ciphertext. |
| Commit(Attr): | Commitment(Attribute), an attribute-related |
| | commitment protocol or a non-interactive |
| | commitment protocol. |
| StorageAddress: | Storage(address)/data storage address |
| CRH(Addr): | Attribute-Based Collision Resistant Hash |
| | Function |
| ZKProv(Attr): | Zero-Knowledge Providence(Attribute), an |
| | attribute-based zero-knowledge proof. |
| Enc(Request_Record): | Encrypt(Request_Record), encrypted request |
| | and record/verification credential. |
| Store(Addr): | Storage(Address), storage (address)/data |
| | storage address. |
| GID: | Group Identification, the unique identifier for |
| | participant traceability, wherein every system |
| | user has a unique identifier GID. |

The present invention provides a system for privacy protection during IoT secure data sharing and its method. More particularly, the system enables IoT data sharing on a blockchain platform to be performed in a secure and encrypted manner using a zero-knowledge proofs with user privacy well protected. The data to be shared are encrypted using the DABE technology and then stored into a cloud server for convenient data sharing. The system combines the zero-knowledge protocol and attribute-based encryption to hide user attributes, and uses edge servers in a decentralized blockchain to verify whether a zero-knowledge proof is valid in a decentralized manner.

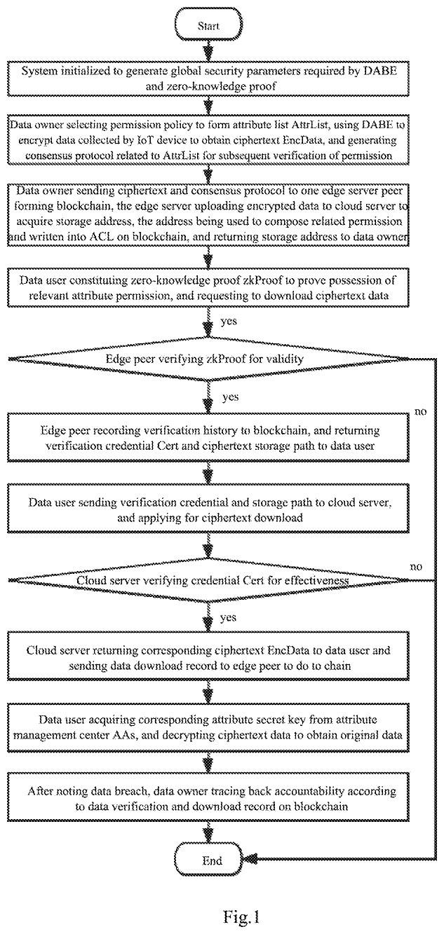

FIG. 1 illustrates a method for privacy protection during IoT secure encrypted data sharing on a blockchain platform based on the zero-knowledge protocol. The method comprises at least one of steps S1 to S9. One or some of the steps S1 to S9 are executed by several modules. The system at least comprises plural modules, cloud servers, edge servers, and at least one attribute authorization agency. At least one of the steps S1 to S9 may be executed by a single module, or may be divided into some sub-steps and executed by plural modules, respectively. Therefore, the first to third modules mentioned in the present invention shall not form limitations to the number of modules contained in the disclosed system. Similarly, the cloud servers, the edge servers, and the at least one attribute authorization agency has at least one module for executing at least one of the steps corresponding thereto. Different from ABE based on a sole authorization center, DABE is achieved by multiple attribute authorization agencies, each of which is in charge of generating components of secret key corresponding to a part of attributes. When a user requesting a secret key has to file applications to all these attribute authorization agencies and uses their replies to compose the final secret key for decryption, thereby achieving decentralization. The attribute authorization agencies do not have to be fully trusted, because none of them can generate the complete secret key for the user. Preferably, the system selects a predetermined number of peers from a blockchain as attribute authorization agencies. The selection may be based on the DPoS (Delegated Proof of Stake) consensus mechanism.

### S1: Initialization.

In the process of system initialization, security parameters are inputs. Every attribute authorization agency generates public parameters and master key according to the attribute collection under his/her management. Therein, the public parameters are kept in secret by the attribute authorization agencies. The first module combines the public parameters published by individual attribute authorization agencies to form the global security parameters required by DABE and the attribute-based zero-knowledge proof when secure sharing of encrypted IoT data is performed on the blockchain platform with user privacy well protected.

Then the global security parameters, the master key pair, and the attribute policy set by the data owner are taken as inputs. Every attribute authorization agency generates the components of the secret key for the data owner according to the attribute policy set by the data owner and sends them to the second module.

### S2: Data Encryption.

The second module is operated by the data owner to use DABE to encrypt the IoT data collected by at least one IoT device.

Preferably, the second module may, based on the secret key components it receives that are generated by all attribute authorization centers, figure out the encrypting key. The second module takes the global security parameters, the access control policy set by the data owner, and the message plaintext as inputs to output the ciphertext EncData corresponding to the IoT data collected by the at least one IoT device.

The second module can generate the attribute-based commitment protocol that is to be combined with DABE in the subsequent stage of permission verification. The commitment protocol is associated with the attribute list AttrList composed according to the attribute permission policy selected by the data owner. Preferably, in order to constitute the commitment protocol of the user, the second module, based on the attribute permission policy selected by the data owner, acquires the user attribute list AttrList, and executes the preset commitment protocol codes, thereby generating the commitment protocol/non-interactive commitment protocol corresponding to the user attribute list AttrList.

### S3: Data Uploading.

The second module sends the ciphertext EncData it obtains by encrypting the IoT data together with the commitment protocol to one of the edge servers forming the blockchain. The edge server uploads the ciphertext EncData to the cloud server, so as to acquire the storage address generated by the cloud server based on the ciphertext EncData. In the present invention, the privacy data are encrypted and then stored into the cloud server, so as to ensure that the cloud server can only acquire the encrypted data, but not the original data, thereby enhancing confidentiality of the privacy data.

After the edge server acquires the storage address, the related permission requirements (i.e., the attribute-based commitment protocol) corresponding to the storage address are written into the access control list ACL on the blockchain. The related permission requirements corresponding to the storage address may refer to the attribute-based commitment protocol. The edge server returns the storage address to the data owner/the second module. The access control list ACL is mainly used to acquire the data storage address corresponding to the data owner permission according to the access control list ACL when the data user requests to verify the permission. The access control list ACL is a permission control list, and is an access control mechanism based on packet filtering. It can filter data packets on the interface according to preset conditions, to allow or reject data packets to pass.

### S4: Permission Request.

The third module is operated by the data user to generate a zero-knowledge proof zkProof that accords with the commitment protocol/non-interactive commitment protocol generated by the second module for the data owner according to the attribute and address selected by the data user. The zero-knowledge proof zkProof is used to prove that the data user initiating the data downloading request possesses relevant attribute permission.

The third module uses the zero-knowledge proof zkProof generated according to the attributes and address selected by the data user to request the edge server for downloading the ciphertext data stored in the edge server.

### S5: Permission Verification.

The edge server, based on the zero-knowledge proof contract pre-compiled on the blockchain, verifies the zero-knowledge proof zkProof it receives from the data user for validity. If the verification succeeds, the edge server generates a verification credential Cert and stores the verification credential Cert together with the verification history for this session to the blockchain. Then the edge server returns the verification credential Cert and storage address that is stored in it and corresponding to the ciphertext EncData to the third module/the data user. If the verification fails, this session of data sharing is terminated. The edge server comprises at least one module that records data permission to be used in subsequent verification.

### S6: Data Download Request.

The third module sends the verification credential Cert and storage address returned by the edge server based on the permission request to the cloud server to apply for downloading the ciphertext EncData corresponding to the storage address.

### S7: Data Download Verification.

The cloud server verifies the verification credential Cert it receives for effectiveness. The effectiveness verification of the credential Cert may be conducted by the cloud server through verifying whether the verification credential Cert exists on the blockchain. If the verification succeeds, the ciphertext EncData corresponding thereto is returned to the third module. If the verification fails, this session of data sharing is terminated.

If the verification of the credential Cert succeeds, the cloud server sends the download record of this session to the edge server for storage.

### S8: Data Decryption.

The third module can acquire the attribute key corresponding thereto from the first module based on the attribute collection of the data user, and uses the acquired attribute key to decrypt the ciphertext, so as to obtain the original data.

If noticing data breach, the data owner can ensure the traceability and accountability according to the verification history and data downloading record stored on the blockchain.

For example, in a blockchain-based medical system, a wearable device worn by a patient publishes information of the health state of the patient to a blockchain on a real-time basis, so that the health state of the patient can be monitored. However, information of the health state of the patient is sensitive in nature, and should be only accessible to medical staff with authorization. Thus, for this kind of information, security protection and flexible access control have to be provided. While encryption may be used to protect information security, the traditional encryption mechanism only supports one-on-one encryption. To be specific, information encrypted using one public key can only be decrypted using a corresponding secret key. Due to his limitation, the traditional encryption mechanism can only ensure information confidentiality, but is unable to provide flexible, fine-grained access control. Focused on this problem, an application scene of a medical IoT according to the present invention will be described below to provide further explanation.

When a patient, as a data owner, wants to share his/her data collected using an IoT device, the patient may select a series of attribute strategies (e.g., location, department, etc.) at the second module, and then use DABE to encrypt the to-be-shared data collected by the IoT device. Preferably, in the present invention, the encryption/decryption process of the to-be-shared data is not further optimized or improved. The encryption/decryption process may be selected from any known DABE encryption/decryption scheme. The second module, according to the attribute strategies selected by the patient, constitutes a hidden non-interactive commitment protocol. The patient may use the second module to upload the encrypted ciphertext and the non-interactive commitment protocol to an edge server. Plural edge servers jointly form a blockchain. The upload record of this uploading session is stored on the blockchain, and the encrypted ciphertext is transmitted to the cloud. The blockchain only records storage addresses generated by the cloud based on the ciphertext and the corresponding non-interactive commitment protocol, so as to reduce storage costs.

The second module has a list maintained by patients. The list contains medical staff members whose permission has to be revoked. The permission of these medical staff member corresponding to encrypted data will be revoked. In addition, for protecting privacy of attributes, the policy adopted by the list is binding the medical staff addresses to the ciphertexts, but not attributes.

When a medical staff member needs to call patient-related information, the medical staff member has to prove that he/she possesses permission that permits him/her to acquire relevant storage addresses from the blockchain. In other words, the medical staff member has to prove his/her ownership on the related attributes. However, any attacker intending to invade the system should no acquire the attributes related to the medical staff, so as to secure privacy of the medical staff, and prevent an attacker from, for example, identify any medical staff member with reference to the attributes. To this end, the present invention employs a zero-knowledge proof to keep the attributes confidential. The second module may, according to the attributes and addresses of the medical staff, upload a zero-knowledge proof zkProof that accords with the non-interactive commitment protocol provided by the data owner. The edge server uses a zero-knowledge proof contract pre-compiled on the blockchain to verify whether the zero-knowledge proof zkProof it receives is correct, thereby verifying the attributes of the medical staff. If the verification succeeds, the medical staff member acquires a storage address and verification credential Cert corresponding to the ciphertext from the blockchain. In this process, since the zero-knowledge proof in the present invention is embedded into the blockchain, due to the decentralized nature of the blockchain, correctness of the zero-knowledge proof has to be verified by plural peers, thereby reducing the risk that any dishonest/malicious verifier counterfeit verification results responsible for attribute breach.

The medical staff member sends to the cloud server the storage address and the verification credential Cert acquired from the blockchain and corresponding to the ciphertext. After the cloud server verifies the effectiveness of the verification credential Cert, the medical staff member can use DABE to decrypt data according to the storage address downloaded from the cloud server, so as to obtain the original data.

The patient may check the data uploading record and the use record on the blockchain through the second module to audit the data flows, and may realize traceability and accountability when according to the records in the event of privacy breach.

The present invention further discloses a model for verifying user attribute permission based on the zero-knowledge proof protocol that is to be used in the system of the present invention. The model combines the zero-knowledge proof protocol and decentralized attribute-based encryption, so that so that when a data user and a data owner share DABE encrypted data therebetween through a cloud server and a blockchain, permission of the data user can be verified simply and efficiently. Different from the traditional practice of acquiring encrypted data directly, the present invention uses an attribute-based credential as permission of a data user, so as to keep user privacy undisclosed, thereby preventing privacy breach otherwise caused by exposure of attributes of data users.

In the present invention, to constitute the attribute-based non-interactive commitment protocol, with a given arbitrary random number r and a secret message (i.e., the attribute list AttrList), an attribute tree AttrTree can be constituted and the attribute tree root AttrRoot can be figured out. On this basis, commitment protocols COMM_{Attr} and COMMᵣ(AttrRoot) can be calculated, and AttrList is hidden from others. With AttrList and r disclosed, anyone can verify whether COMM_{Attr} and COMMᵣ(AttrRoot) are equivalent. Therein, the pseudo random number sorting function (PSF) is first used to sort AttrList and fill a certain number of 0s into AttrList to ensure list length consistency so as to obfuscate the attribute list. Then, the collision resistant hash function CHR is used to construct a Merkle tree attr_MerkleTree with a fixed depth to store AttrList. Afterward, the Merkle tree root is figured out, which is the foregoing attribute tree root AttrRoot.

In the method, the data owner establishes the attribute permission policy, and constitutes the non-interactive commitment protocol according to the policy.

Preferably, with a given arbitrary random number r and a secret message (i.e., the attribute list AttrList), an attribute tree AttrTree can be constituted and the attribute tree root AttrRoot can be figured out. On this basis, commitment protocols COMM_{Attr} and COMMᵣ(AttrRoot) can be calculated.

In the method, an attribute-based zero-knowledge proof according with the commitment protocol is generated based on the attribute and address of the data user.

In order to hide privacy information, such as user identity permission, the present invention uses a zero-knowledge proof to verify user identity and thereby hide the attribute list AttrList. In addition, the zero-knowledge proof is bound to a user address. The arrangement helps resist replay attacks. Specifically, a replay attack happens when noting COMM_{Attr}, an attacker directly uses it to counterfeit a proof to prove that the attacker satisfies the attributes. In addition to using the COMM_{Attr} proof to satisfy the attributes, the present invention further uses COMM′_{Attr} to bind the address of a doctor to prove ownership of and access to the attributes.

Preferably, a user (herein the data user) first, based on the random number r, the attribute list AttrList and the user address addr_DU, generates the commitment protocol COMM_{Attr}:=COMMᵣ(AttrRoot) and COMM′_{Attr}:=COMM_{addr_DU}(AttrRoot). Then according to COMM_{Attr}, COMM′_{Attr}, r, AttrList, an addr_DU, a zero-knowledge proof zkProv can be generated. For easy understanding, in the above description, “:=” represents “defined as,” and is a symbol in the programming language for an assignment statement, which is used to define a newly appearing symbol. This is to define the newly defined symbol as expressing the value at the left.

In the method, each of the commitment protocol and the attribute-based zero-knowledge proof does not contain any attributes of the corresponding user.

In the method, a zero-knowledge proof contract pre-compiled based on the commitment protocol is used to verify the attribute-based zero-knowledge proof. Then a verification result will be output. The foregoing verification may be directed to the following NP-hard statement:

I know that the attribute permission list AttrList is a secret input, the public input addr_DU, and the random number r, and through the non-interactive commitment protocol Commitment, we can acquire COMM_{Attr} and COMM′_{Attr}.

Preferably, the NP-hard statement construction: Public inputs: COMMₐₜₜᵣ, COMM′ₐₜₜᵣ, r, addr_DU Private inputs: attr₀, . . . , attrₙ.

```
  AttrList=PSF(attr₀,..., attrₙ,...,0x00...0),
  AttrRoot=BuildMerkleTree(AttrList),
COMM_{Attr} := COMMᵣ(AttrRoot), COMM′_{Attr} :=
COMM_{addr}_{_{—}}_{DU}(AttrRoot).
```

It should be noted that the above-mentioned specific embodiments are exemplary, and those skilled in the art can come up with various solutions inspired by the disclosure of the present invention, and those solutions also fall within the disclosure scope as well as the protection scope of the present invention. It should be understood by those skilled in the art that the description of the present invention and the accompanying drawings are illustrative rather than limiting to the claims. The protection scope of the present invention is defined by the claims and their equivalents. The description of the present invention contains a number of inventive concepts, such as “preferably”, “according to a preferred embodiment” or “optionally” all indicate that the corresponding paragraph discloses an independent idea, and the applicant reserves the right to file a divisional application based on each of the inventive concepts.

What is claimed is:

1. A method for privacy protection during IoT secure data sharing, at least comprising:
performing, by edge servers forming a blockchain, verification on an attribute-based zero-knowledge proof coming from a data user requesting for download permission;
if the verification succeeds, having the data user transmit information, which at least contains a storage address and is returned by the edge server, to a cloud server to file an application for downloading a ciphertext;
performing, by the cloud server, verification on the application, and if the verification succeeds, returning the ciphertext to the data user, wherein the ciphertext is obtained by encrypting, by a data owner, to-be-shared data through decentralized attribute-based encryption (DABE); and
decrypting, by the data owner, the ciphertext based on DABE so as to obtain original data.

2. The method of claim 1, further comprising: by the data owner, establishing and constituting an attribute list, encrypting the to-be-shared data using DABE to obtain the ciphertext, and generating a commitment protocol associated with the attribute permission list.

3. The method of claim 2, further comprising: by the data owner, transmitting the ciphertext and the commitment protocol to an edge server to upload the ciphertext to the cloud server, thereby obtaining the storage address associated with the ciphertext.

4. The method of claim 3, further comprising: by the edge server, using the storage address to compose related permission, writing the permission into an access control list (ACL) on the blockchain, and returning the storage address to data owner.

5. The method of claim 4, wherein the information that is returned by the edge server after verifying the attribute-based zero-knowledge proof transmitted by the data user at least includes a verification credential, wherein the verification credential is used by the cloud server to determine whether the application for downloading the ciphertext is to be approved.

6. The method of claim 5, wherein the data user acquires, from an attribute authorization agency, an attribute key corresponding to the ciphertext, and decrypts data of the ciphertext based on the attribute key.

7. The method of claim 6, further comprising: performing system initialization to generate global security parameters required by DABE and the attribute-based zero-knowledge proof, wherein each said attribute authorization agency generates a corresponding private/public key pair.

8. A method for privacy protection during IoT secure data sharing, at least comprising:
by a data owner, establishing an attribute permission policy and constituting a non-interactive commitment protocol according to the policy;
based on an attribute and an address of a data user, generating an attribute-based zero-knowledge proof that accords with the commitment protocol;
wherein neither the commitment protocol nor the attribute-based zero-knowledge proof discloses any attribute associated with the respective corresponding users;
using a zero-knowledge proof contract pre-compiled based on the commitment protocol to perform the verification on the attribute-based zero-knowledge proof; and
outputting a verification result.

9. The method of claim 8, wherein the commitment protocol is obtained through a process of constituting a Merkle attribute tree based on the attribute list and computing a Merkle tree root and a given random number, and the process may comprise:
using a pseudo random number sorting function to sort the attribute list and filling a certain number of 0s in the attribute list to ensure list length consistency and thereby obfuscate the attribute list; and
using a Collision Resistant Hash Function to construct the Merkle tree having a fixed depth to store the attribute list, and figuring out the Merkle tree root through computing.

10. A system for privacy protection during IoT secure data sharing, at least comprising plural modules, wherein the modules are assigned to execute at least one of steps of:
being used by a data owner to encrypt to-be-shared data by means of DABE, and/or store a ciphertext and permission to a cloud server;
being used by a data user to prove his/her attribute permission and file an application for obtaining a data storage address;
being used by an edge node to perform verification on user permission and return a verification credential and the ciphertext data storage address to the data user;
being used by the data user to, after obtaining the credential and the storage address, filing an application at the cloud server for data downloading; and
being used by the cloud server to perform verification on the credential for effectiveness and return the ciphertext to the data user.

11. The system of claim 10, wherein the modules are further assigned to execute the step of: by the data owner, establishing and constituting an attribute list, encrypting the to-be-shared data using DABE to obtain the ciphertext, and generating a commitment protocol associated with the attribute permission list.

12. The system of claim 11, wherein the modules are further assigned to execute the step of: by the data owner, transmitting the ciphertext and the commitment protocol to an edge server to upload the ciphertext to the cloud server, thereby obtaining the storage address associated with the ciphertext.

13. The system of claim 12, wherein the modules are further assigned to execute the step of: by the edge server, using the storage address to compose related permission, writing the permission into an access control list (ACL) on the blockchain, and returning the storage address to data owner.

14. The system of claim 13, wherein the information that is returned by the edge server after verifying the attribute-based zero-knowledge proof transmitted by the data user at least includes a verification credential, wherein the verification credential is used by the cloud server to determine whether the application for downloading the ciphertext is to be approved.

15. The system of claim 14, wherein the data user acquires, from an attribute authorization agency, an attribute key corresponding to the ciphertext, and decrypts data of the ciphertext based on the attribute key.

16. The system of claim 15, wherein the modules are further assigned to execute the step of: performing system initialization to generate global security parameters required by DABE and the attribute-based zero-knowledge proof, wherein each said attribute authorization agency generates a corresponding private/public key pair.

17. The system of claim 10, wherein the modules are further assigned to execute at least one of the steps of:
by a data owner, establishing an attribute permission policy and constituting a non-interactive commitment protocol according to the policy;
based on an attribute and an address of a data user, generating an attribute-based zero-knowledge proof that accords with the commitment protocol;
wherein neither the commitment protocol nor the attribute-based zero-knowledge proof discloses any attribute associated with the respective corresponding users;
using a zero-knowledge proof contract pre-compiled based on the commitment protocol to perform the verification on the attribute-based zero-knowledge proof; and
outputting a verification result.

18. The system of claim 17, wherein the modules are further assigned to execute the step of:
constituting a Merkle attribute tree based on the attribute list and computing a Merkle tree root and a given random number, and the process may comprise:
using a pseudo random number sorting function to sort the attribute list and filling a certain number of 0s in the attribute list to ensure list length consistency and thereby obfuscate the attribute list; and
using a Collision Resistant Hash Function to construct the Merkle tree having a fixed depth to store the attribute list, and figuring out the Merkle tree root through computing.

19. The system of claim 18, wherein the modules are further assigned to execute the step of: by the data owner, establishing and constituting an attribute list, encrypting the to-be-shared data using DABE to obtain the ciphertext, and generating a commitment protocol associated with the attribute permission list.

20. The system of claim 19, wherein the modules are further assigned to execute the step of: by the data owner, transmitting the ciphertext and the commitment protocol to an edge server to upload the ciphertext to the cloud server, thereby obtaining the storage address associated with the ciphertext.
